(19) United States
(12) Patent Application Publication
(10) Pub. No.: US 2025/0083196 A1
(43) Pub. Date: Mar. 13, 2025

(54) Pressure Washer

(71) Applicant: Andreas Stihl AG & Co. KG, Waiblingen (DE)

(72) Inventors: Alexander Kiebler, Kirchberg an der Murr (DE); Lukas Zürcher, Ludwigsburg (DE); Christopher Tost, Auenwald (DE)

(73) Assignee: Andreas Stihl AG & Co. KG, Waiblingen (DE)

(21) Appl. No.: 18/830,005

(22) Filed: Sep. 10, 2024

(30) Foreign Application Priority Data
Sep. 12, 2023 (DE) 102023124588.0

(51) Int. Cl. B08B 3/02

(52) U.S. Cl. CPC B08B 3/026; B08B 2203/0223; B08B 2203/027

(57) ABSTRACT

The invention relates to a pressure washer (1) comprising a port (2) for a liquid source (3), a high-pressure pump (4), a main line (5), through which liquid can be conveyed from the port (2) to a spray opening (6) of the main line (5) by the high-pressure pump (4), and a first electric motor (10) for driving the high-pressure pump (4), which generates a first amount of power. The pressure washer (1) comprises a second electric motor (20) for driving the high-pressure pump (7), which generates a second amount of power. The pressure washer (1) comprises a gearbox (30), which comprises an output shaft (31) for driving the high-pressure pump (4). The gearbox (30) is designed in such a way that the first amount of power and the second amount of power can be used simultaneously to drive the output shaft (31) of the gearbox (30).

### CROSS-REFERENCE TO RELATED APPLICATION

This application claims the benefit of German Patent Application DE 102023124588.0, filed on Sep. 12, 2023, the content of which is incorporated by reference in its entirety.

### BACKGROUND

The disclosure relates to a pressure washer. The high-pressure pump of a pressure washer is typically driven by an electric motor. Pressure washers are generally powered by a corded connection to an electrical outlet. The electric motor receives electrical energy from an external power source, such as a public power grid. The available power from the public power grid varies in different countries. In the German power grid, for example, the available power is approximately 3.5 kW. In the US power grid, it is comparatively lower at around 1.9 kW. The peak power of the high-pressure pump/the electric motor therefore varies depending on the power available in the public power grid.

### SUMMARY

The present application improves a generic pressure washer in such a way that a peak power of its high-pressure pump can exceed a lower available power from a public power grid.

This is achieved by a pressure washer which includes a first electric motor for driving the high-pressure pump. The first electric motor generates a first amount of power. In particular, the first electric motor generates a first torque. In addition to the first electric motor, a second electric motor is provided. The second electric motor also serves to drive the high-pressure pump. The second electric motor generates a second amount of power. In particular, the second electric motor generates a second torque.

The pressure washer comprises a gearbox. The gearbox includes an output shaft to drive the high-pressure pump. In particular, the output shaft is directly connected to the high-pressure pump. The gearbox is designed such that the first electric motor and the second electric motor can be used simultaneously to drive the output shaft of the gearbox. The first amount of power provided by the first electric motor and the second amount of power provided by the second electric motor can be simultaneously transferred to the high-pressure pump. In particular, the gearbox is designed in such a way that the first torque provided by the first electric motor and the second torque provided by the second electric motor can be used simultaneously to drive the output shaft of the gearbox.

In particular, the first amount of power of the first electric motor and the second amount of power of the second electric motor are transmitted to the single output shaft of the gearbox. As a result, the first amount of power and the second amount of power are combined. In particular, the first torque of the first electric motor and the second torque of the second electric motor can be used simultaneously to drive the output shaft of the gearbox. In particular, the first torque and the second torque can simultaneously contribute to driving the output shaft. Depending on a configuration of the gearbox, the torque of the output shaft may be greater than the first torque. The torque of the output shaft may also be greater than the second torque. In particular, the power provided by the output shaft is greater than the first amount of power of the first electric motor alone. In particular, the power provided by the output shaft is greater than the second amount of power of the second electric motor alone.

In particular, the gearbox adds the first amount of power and the second amount of power.

Because a gearbox is provided, by which the first amount of power and the second amount of power can be used simultaneously to drive the output shaft of the gearbox, both the first electric motor and the second electric motor can simultaneously contribute to driving the output shaft during operation of the pressure washer with a peak power of the high-pressure pump, in particular during boost operation of the pressure washer. If the first electric motor is operated with an energy source whose power is below the desired peak power of the high-pressure pump, the second electric motor can compensate for a power difference. This makes it possible, within certain limits, to operate the high-pressure pump at peak power, regardless of the power available for the first electric motor.

Because the first electric motor and the second electric motor can be used simultaneously to drive the output shaft, the pressure washer can still be used even if one of the two electric motors or another component of the associated drive train fails. Because the first amount of power of the first electric motor and the second amount of power of the second electric motor are mechanically transmitted to the output shaft by means of a gearbox, the two electric motors can be supplied with electrical power by completely separate electrical systems. The two electrical systems do not influence each other. This results in good electromagnetic compatibility.

The first electric motor is preferably an alternating current (AC) motor. In particular, the first electric motor is a universal motor.

The second electric motor is preferably a direct current (DC) motor. In particular, the second electric motor is a brushless direct current motor. In particular, the second electric motor is an electronically commutated motor.

The pressure washer is preferably designed in such a way that the first electric motor can be supplied from an external energy source. In particular, the pressure washer is designed in such a way that the first electric motor can be supplied by an AC voltage, in particular by a mains voltage from a power grid.

In an advantageous configuration, the pressure washer comprises an electrical energy source. In particular, the electrical energy source is a battery. The battery may be rechargeable. In particular, the pressure washer is configured to allow the second electric motor to be supplied with electrical energy by the electrical energy source. As a result, a power difference, for example due to a smaller grid power with which the first electric motor is operated, can be compensated by the second electric motor.

Because the gearbox is designed in such a way that the first amount of power and the second amount of power can be used simultaneously to drive the output shaft of the gearbox, there are several options for driving the output shaft. The pressure washer can be used more flexibly overall.

In a particular configuration, the gearbox is designed in such a way that the output shaft can be driven selectively simultaneously with the first electric motor and the second electric motor, in particular with the first amount of power and the second amount of power, in particular with the first torque and the second torque, or can be driven exclusively either with the first electric motor or with the second electric motor, in particular exclusively with either the first amount of power or the second amount of power, in particular exclusively with either the first torque or the second torque. This means that the second electric motor may only be switched on in situations where it is necessary. It is also conceivable for the high-pressure pump to be driven by only a single energy source, for example the rechargeable battery or, for example, a public power grid. This enables flexible use of the pressure washer, for example even away from a public power grid.

In particular, the gearbox comprises at least one freewheel. When the output shaft is driven by only one of the two electric motors, the freewheel expediently prevents any power transmission, in particular any torque transmission from the active electric motor to the inactive electric motor. This prevents energy from being lost unintentionally. This also makes it possible to operate the high-pressure pump with one of the two electric motors alone.

Advantageously, the first electric motor and the second electric motor are completely electrically separated from each other. This creates reliable redundancy of the two drive trains and prevents mutual influence of the two energy sources. The energy source of the first electric motor cannot have any impact on the energy source of the second electric motor. Conversely, the energy source of the second electric motor cannot have any impact on the energy source of the first electric motor. This ensures good electromagnetic compatibility.

In particular, the gearbox has a single output shaft.

The gearbox is expediently a planetary gear system. In particular, the planetary gear system comprises a sun gear, a ring gear, and planet gears.

The pressure washer is advantageously configured to allow the sun gear to be driven by one of the two electric motors and to allow the ring gear to be driven by the other of the two electric motors. In particular, the pressure washer is configured to allow the sun gear to be driven by the first electric motor and to allow the ring gear to be driven by the second electric motor. The pressure washer is expediently configured to allow the output shaft to be driven by the planet gears, which in turn are driven by the sun gear and/or the ring gear. In particular, the output shaft for driving the high-pressure pump can rotate about an axis of rotation. In particular, the planet gears can be driven by the sun gear and/or the ring gear, causing them to rotate around the axis of rotation.

The ring gear conveniently has external teeth on its outer circumference and internal teeth on its inner circumference. In particular, the power, in particular the torque, in particular the force of the one electric motor, in particular the second electric motor, is transmitted to the ring gear by the external toothing. In particular, the torque of the ring gear is transmitted from the ring gear to the planet gears by the internal toothing.

An embodiment of the invention is explained below with reference to the drawings.

### BRIEF DESCRIPTION OF THE DRAWINGS

FIG. 1 is a perspective, schematic view of a pressure washer, FIG. 2 shows a schematic sketch of the structure of the pressure washer from FIG. 1,

FIG. 3 shows a perspective, schematic view of the two electric motors, the gearbox and the high-pressure pump of the pressure washer from FIGS. 1 and 2,

FIG. 4 is a sectional view of a horizontal section through the arrangement of FIG. 3, and

FIG. 5 is a sectional view of a section along the section line V-V from FIG. 4.

### DETAILED DESCRIPTION

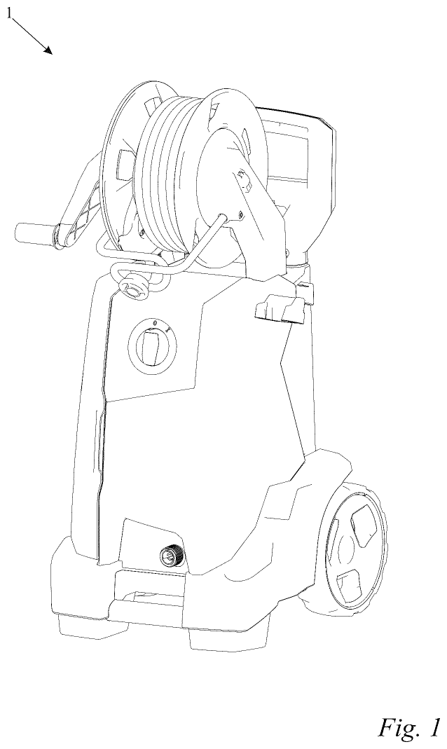

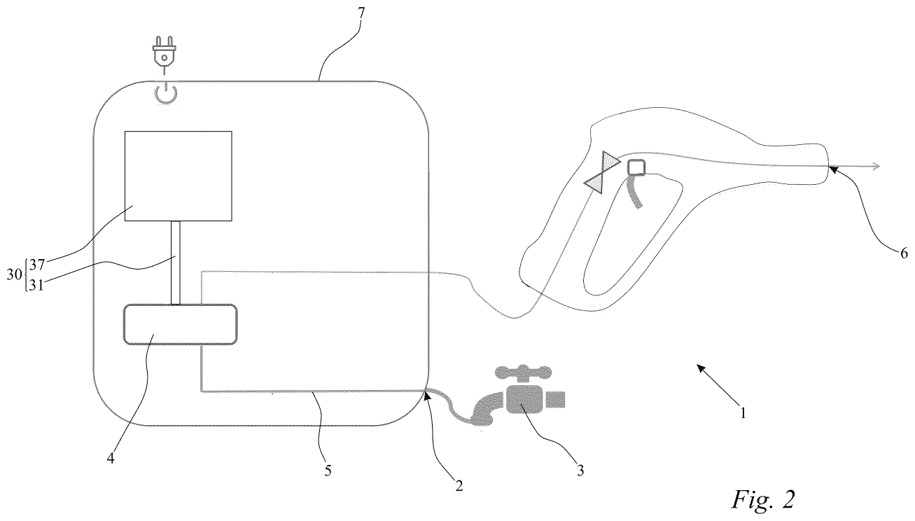

FIG. 1 shows a pressure washer 1, which may also be referred to as a high-pressure cleaning apparatus. The pressure washer 1 is designed for cleaning objects with pressurized cleaning fluid. In the exemplary embodiment, the pressure washer 1 is provided with wheels for easy rolling. However, it can also be provided that the pressure washer 1 is portable. During normal operation, the pressure washer 1 is set down on the ground. In the exemplary embodiment, the pressure washer 1 is a cold-water pressure washer.

As shown in FIG. 2, the pressure washer 1 comprises a port 2 for a liquid source 3. The port 2 may be an inlet water connector. In the exemplary embodiment, the liquid source 3 is an external liquid source. In the exemplary embodiment, the external liquid source is the tap of a domestic water network. The liquid source may also be an integral part of the pressure washer.

The pressure washer 1 comprises a spray opening 6. The pressure washer 1 comprises a main line 5. The main line 5 of the pressure washer 1 fluidically connects the port 2 to the spray opening 6. In the exemplary embodiment, the spray opening 6 is arranged on a spray unit. The spray unit is designed in particular as a spray gun. It can also be provided that the spray opening is arranged on a replaceable lance of the spray unit.

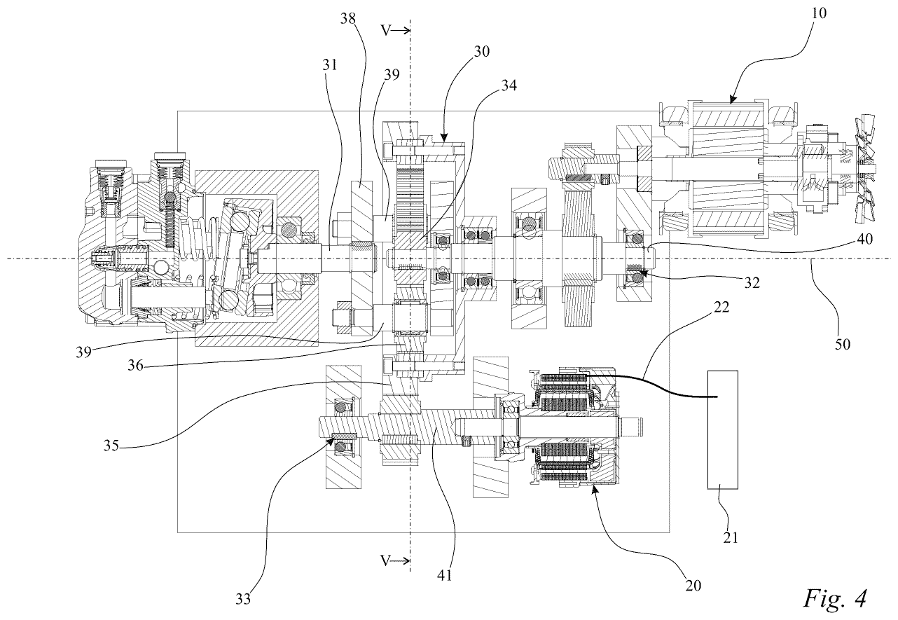

The pressure washer 1 comprises a high-pressure pump 4. By means of the high-pressure pump 4, liquid can be conveyed from the port 2 to the spray opening 6 through the main line 5. The liquid source 3 is fluidically connected to the main line 5. The high-pressure pump 4 is arranged in the main line 5. The high-pressure pump 4 pressurizes the liquid. By means of the high-pressure pump 4, the cleaning liquid can be placed under a pressure of at least 10 bar, in particular of at least 15 bar, in particular of at least 30 bar, in particular of at least 100 bar. In particular, the high-pressure pump 4 can pressurize the cleaning fluid to a maximum of 600 bar, in particular a maximum of 500 bar. In the exemplary embodiment, the high-pressure pump 4 comprises a swash plate, as shown in FIG. 4.

The main line 5 may include an inlet line from the port 2 to the high-pressure pump 4 and a pressure hose from the high-pressure pump 4 to the spray opening 6.

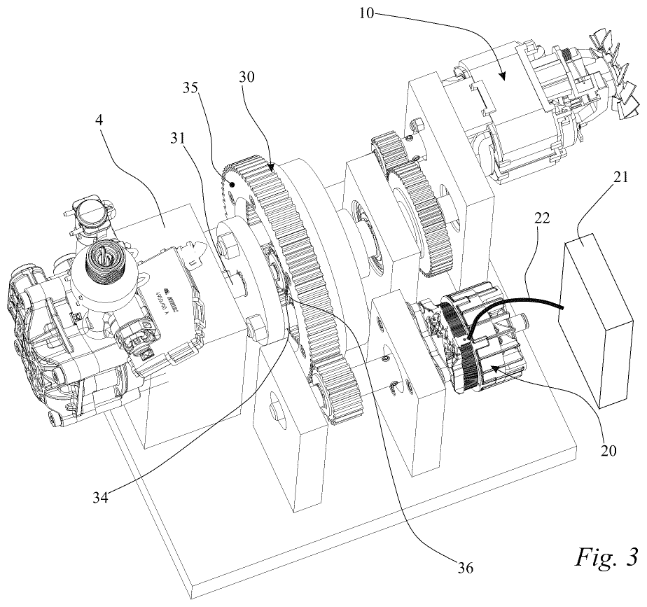

The pressure washer 1 has a housing 7 (FIG. 3). The high-pressure pump 4 is arranged in the housing 7. The main line 5 is arranged at least partially in the housing 7. The spray unit is arranged outside the housing 7. The spray unit is connected to the housing via the main line 5.

The pressure washer 1 comprises a gearbox 30. The gearbox 30 has an output shaft 31. The gearbox 30 has a gearbox housing 37. The gearbox 30 is arranged in the housing 7 of the pressure washer 1. The output shaft 31 serves to drive the high-pressure pump 4. The output shaft 31 protrudes from the gearbox housing 37 of the gearbox 30. The output shaft 31 is connected to the high-pressure pump 4. In the exemplary embodiment, the output shaft 31 is connected to the high-pressure pump 4 in such a way that a rotation of the output shaft 31 causes a rotation of a swash plate of the high-pressure pump 4. The gearbox 30 has only a single output shaft 31.

As shown in FIG. 3, the pressure washer 1 comprises a first electric motor 10. The pressure washer 1 comprises a second electric motor 20. The first electric motor 10 is formed separately from the second electric motor 20. The first electric motor 10 and the second electric motor 20 are completely electrically separated from each other. The first electric motor 10 generates a first amount of power. The first electric motor 10 generates in particular a first torque. The second electric motor 20 generates a second amount of power. In particular, the second electric motor 20 generates a second torque. The gearbox 30 is designed in such a way that the first amount of power and the second amount of power can be used simultaneously to drive the output shaft 31 of the gearbox 30. In particular, the gearbox 30 is designed in such a way that the first torque and the second torque can be used simultaneously to drive the output shaft 31 of the gearbox 30.

The power generated by the first electric motor 10 can be mechanically transmitted to the output shaft 31 by the gearbox 30. In particular, the first torque generated by the first electric motor 10 can be mechanically transmitted to the output shaft 31 by means of the gearbox 30. The power generated by the second electric motor 20 can be mechanically transmitted to the output shaft 31 by means of the gearbox 30. In particular, the second torque generated by the second electric motor can be mechanically transmitted to the output shaft 31 by means of the gearbox 30.

At constant speed, the power and the torque of the electric motors 10, 20 are proportional to one another. The product of torque and speed gives the power generated.

The gearbox 30 is designed in such a way that the output shaft 31 can be driven selectively simultaneously by the first electric motor with the first amount of power and by the second electric motor with the second amount of power. Alternatively, the output shaft 31 can be driven exclusively by one of the two electric motors. In the exemplary embodiment, the gearbox is designed in such a way that the gearbox 30 simultaneously uses the first amount of power of the first electric motor 10 and the second amount of power of the second electric motor 20 to generate a total power. The total power is greater than the first amount of power. The total power is greater than the second amount of power. In particular, the gearbox is designed in such a way that the first torque and the second torque interact to generate a total torque. Depending on a transmission ratio of the gearbox 30, the total torque may be greater than the first torque. The total torque may be greater than the second torque. The total torque may be less than or equal to the sum of the first torque and the second torque.

The total power is the power with which the output shaft 31 drives the high-pressure pump 4. The total torque is the torque with which the output shaft 31 drives the high-pressure pump 4.

The first electric motor 10 shown in FIG. 3 is an alternating current motor. In the exemplary embodiment, the first electric motor 10 is a universal motor. A universal motor is a single-phase series motor. A universal motor can be operated with both direct and alternating current. A universal motor can also be referred to as a single-phase commutator motor. The universal motor comprises a fixed part, the stator, and a movable part, the rotor. The magnetic field in both the rotor and the stator is generated by current-carrying coils. The rotors have mechanical commutation. For this purpose, sliding contacts are generally provided, which interact with brushes, in particular carbon brushes. The sliding contacts are arranged in such a way that, during rotation, they change the polarity of the armature winding in such a way that current always flows through that winding which moves transversely to the excitation field. The commutator acts together with the brushes as a mechanical switch. The commutator ensures that the current flow through the coils of the rotor reverses precisely when the south pole of the rotor and the north pole of the stator are close together. When the current direction is reversed, the magnetic poles of the rotor also reverse.

The second electric motor 20 is a direct current motor. In particular, the second electric motor 20 is a brushless direct current motor. In particular, the second electric motor is an electronically commutated motor. The electronically commutated motor is also called EC motor. Here, control electronics convert the direct current into a suitable three-phase current. The three-phase winding is controlled by a suitable circuit in such a way that it generates a migrating magnetic field, which pulls the rotor along.

The pressure washer 1 is designed in such a way that the first electric motor 10 can be supplied by an external energy source. In particular, the electric motor 10 can be supplied by an alternating voltage. In particular, the first electric motor 10 can be supplied by mains voltage. The mains voltage is the voltage provided by a public power grid. Mains voltage is the electrical voltage provided by energy suppliers in the power grids, which is used to transmit electrical energy. In different countries the mains voltage may have different characteristics. In Europe, the mains voltage is 230 V±23 V with a mains frequency of 50 Hz±0.2 Hz. In Canada, the USA, Mexico and some northern countries in South America, the nominal AC mains voltage is 120 V. The mains frequency is 60 Hz.

As shown in FIG. 3, the pressure washer 1 comprises an electrical energy source 21. The electrical energy source 21 is used to supply the second electric motor 20 with electrical energy. The electrical energy source 21 is arranged in or on the housing 7 shown in FIG. 2. The electrical energy source 21 is, in particular, interchangeable. In the exemplary embodiment, the electrical energy source 21 is a rechargeable battery. However, it can also be provided that the electrical energy source 21 is a non-rechargeable battery. The pressure washer 1 is configured to supply the second electric motor 20 with electrical energy from the electrical energy source 21. The electrical energy source 21 is a direct voltage source. In the exemplary embodiment, the electrical energy source 21 has a nominal voltage in the range from 10 V to 80 V, in particular from 18 V to 72 V, most particularly from 30 V to 40 V.

As shown in FIG. 4, the gearbox 30 comprises at least one freewheel 32, 33. When the output shaft 31 is driven by only one of the two electric motors 10, 20, the at least one freewheel 32, 33 prevents a power transmission, in particular a torque transmission from the active electric motor 10, 20 to the inactive other electric motor 10, 20. In the exemplary embodiment, a first freewheel 32 is provided. The first freewheel 32 prevents a power transmission, in particular a torque transmission from the second electric motor 20 to the first electric motor 10. In the exemplary embodiment, a second freewheel 33 is provided. The second freewheel 33 prevents a power transmission, in particular a torque transmission from the first electric motor 10 to the second electric motor 20. The freewheel 32, 33 locks the transmission of a torque that would drive the motor shaft of the electric motor 10, 20 in a certain direction.

The gearbox 30 is a planetary gear system. The planetary gear system is also referred to as an epicyclic gear system. Planetary gear systems include toothed gears or friction gears that, in addition to shafts fixed to the frame, also have axles that rotate on circular paths in the frame. Accordingly, a distinction is made between the central or sun gears mounted on the frame-fixed axles and the orbital or planet gears mounted on the rotating axles. The gears rotating on the rotating axes orbit a central gear similar to planets orbiting the sun. The carrier, which carries the rotating axes, in turn rotates about an axis fixed to the frame.

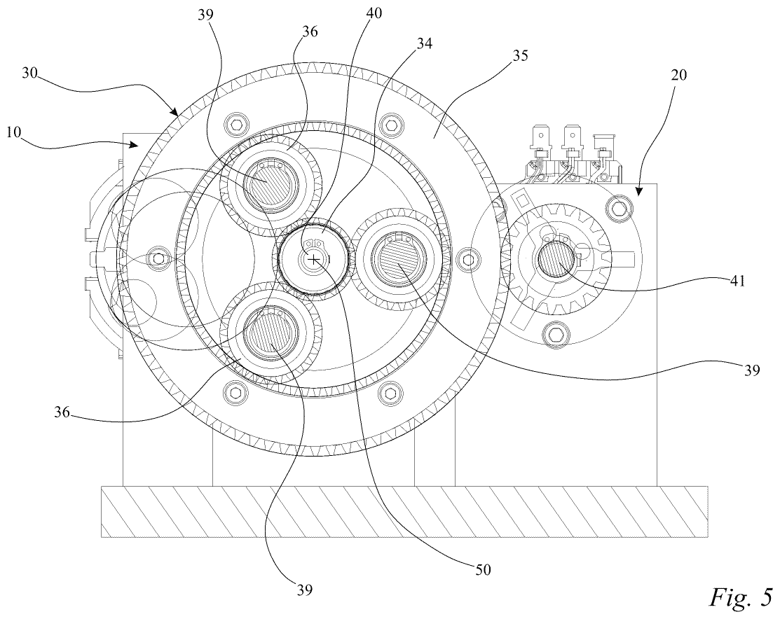

In the exemplary embodiment, the output shaft 31 is fixed to this carrier. In the exemplary embodiment, the planetary gear system is a toothed gear system. As shown in FIG. 5, the gearbox 30 comprises a sun gear 34, a ring gear 35, and planet gears 36. The pressure washer 1 is designed in such a way that one of the two electric motors 10, 20 can drive the sun gear 34 and that the other of the two electric motors 10, 20 can drive the ring gear 35. In the exemplary embodiment, it is provided that the sun gear 34 can be driven by the first electric motor 10 and that the ring gear 35 can be driven by the second electric motor 20. The pressure washer 1 is designed in such a way that the output shaft 31 can be driven by the planet gears 36. The planet gears 36 are driven by the sun gear 34 and/or the ring gear 35. For driving the high-pressure pump 1, the output shaft 31 can rotate about an axis of rotation 50. The planet gears 36 can be driven to rotate around the axis of rotation 50. The planet gears 36 can be driven by the sun gear 34 and/or the ring gear 35, causing them to rotate around the axis of rotation 50. The planet gears 36 may be driven by either the sun gear 34 or the ring gear 35, or both the sun gear 34 and the ring gear 35.

The gearbox 30 comprises a carrier 38. In the exemplary embodiment, the carrier 38 is a plate. In the exemplary embodiment, the carrier 38 has the shape of a flat cylinder. However, other shapes are also possible for the carrier 38. For example, the carrier 38 can be star-shaped. The carrier 38 is connected to each planet gear 36 via a respective planet shaft 39, as shown in FIG. 4. The carrier is also called the planet carrier. In the exemplary embodiment, a total of three planet gears 36 are provided. The three planet gears 36 are arranged at an angular distance of 120° from each other with respect to the axis of rotation 50. These angular distances remain during the rotation of the planet gears 36 around the axis of rotation 50. In the exemplary embodiment, each planet gear 36 is rotatably mounted on a planet shaft 39. The carrier 38 is connected to the output shaft 31 in a rotationally fixed manner. The output shaft 31 runs coaxially with the axis of rotation 50. During a rotational movement of the planet gears 36, the carrier 38 and thus also the output shaft 31 rotate about the axis of rotation 50.

The sun gear 34 can be set in rotation by means of the first electric motor 10. The sun gear 34 is connected to the motor shaft of the first electric motor 10 via a sun shaft 40 and a corresponding gear. The gears between the sun shaft 40 and the motor shaft of the first electric motor 10 represent a first transmission pre-stage. The first transmission pre-stage serves to reduce the rotational speed of the sun shaft 40 compared to the rotational speed of the first electric motor 10.

The sun shaft 40 is mounted in the housing 7 via the first freewheel 33 at a bearing point opposite the sun gear 34. The first freewheel 32 allows only a rotational movement of the sun shaft 40 in one direction. In the other direction, the first freewheel 32 prevents the rotational movement of the sun shaft 40. When the high-pressure pump 4 is driven exclusively by the second electric motor 20, the first freewheel 32 provides a counter-torque that prevents rotational movement of the sun gear 34 and the sun shaft 40. The planet gears 36 can then rotate on the stationary sun gear 34 around the axis of rotation 50. By locking the first freewheel 32, the transmission of the second amount of power, in particular the second torque, from the second electric motor 20 to the output shaft 31 is possible by means of the gearbox 30.

The gearbox 30 comprises a ring gear drive shaft 41. In the exemplary embodiment, the ring gear drive shaft 41 runs coaxially with the motor shaft of the second electric motor 20. The ring gear drive shaft is offset from the axis of rotation 50. The ring gear drive shaft 41 runs parallel to the axis of rotation 50. The ring gear 35 can be driven via the ring gear drive shaft 41 by the second electric motor 20. In the exemplary embodiment, the ring gear 35 is pot-shaped. In the exemplary embodiment, the ring gear 35 is rotatably mounted on the sun shaft 40. The ring gear 35 has external teeth on its outer circumference. The second amount of power, in particular the second torque, is transmitted from the second electric motor 20 to the ring gear 35 by a corresponding gearwheel on the ring gear drive shaft 41. The external toothing of the ring gear 35 and the gear on the ring gear drive shaft 41 represent a second transmission pre-stage. The second transmission pre-stage serves to reduce the rotational speed of the ring gear drive shaft 41 compared to the rotational speed of the second electric motor 20.

The ring gear drive shaft is mounted at its longitudinal end facing away from the second electric motor 20 in the housing 7 by means of the freewheel 33. The second freewheel 33 allows a rotational movement of the ring gear drive shaft 41 in only one direction of rotation. The second freewheel 33 blocks the ring gear drive shaft 41 from rotating in the other direction. When the output shaft 31 is driven exclusively by the first electric motor 10, the second freewheel 33 prevents a rotation of the ring gear drive shaft 41. The second freewheel 33 then creates a counter torque for the ring gear 35. The second freewheel 33 then holds the ring gear 35. As a result, the first amount of power provided by the first electric motor 10, in particular the first torque provided by the first electric motor 10, can be transmitted to the output shaft 31 by the gearbox 30. In this case, the ring gear 35 is stationary, so that the planet gears 36 can rotate on the ring gear 35.

The sun gear 34 has external teeth. The external toothing of the sun gear 34 interacts with the external toothing of the planet gears 36. The internal toothing of the ring gear 35 interacts with the external toothing of the planet gears 36. During the movement of the planet gears 36, the planet shafts 39 move with the planet gears 36 around the axis of rotation 50. Since the planet gears 36 are rotatably mounted on the planet shafts 39 and the planet shafts are fixed to the carrier 38, the carrier 38 also rotates around the axis of rotation 50 when the planet shafts 39 rotate around the axis of rotation 50. Since the carrier 38 is connected to the output shaft 31 in a rotationally fixed manner, the output shaft 31 rotates when the carrier 38 rotates.

When the output shaft 31 of the gearbox 30 is driven simultaneously by the first amount of power of the first electric motor 10 and by the second amount of power of the second electric motor 20, the planet gears 36 are driven by both the sun gear 34 and the ring gear 35, in particular by the internal toothing of the ring gear 35. The first freewheel 32 then allows a corresponding rotational movement of the sun shaft 40. The second freewheel 33 then allows a corresponding rotational movement of the ring gear drive shaft 41. The ring gear 35 and the sun gear 34 then rotate in the same direction of rotation around the axis of rotation 50. The first electric motor 10 and the second electric motor 20 then rotate in the same direction of rotation.

What is claimed is:

1. A pressure washer, comprising:
a port (2) for connecting the pressure washer to a liquid source (3);
a high-pressure pump (4);
a gearbox (30) with an output shaft (31) for driving the high-pressure pump (4);
a main line (5), through which liquid can be conveyed from the port (2) to a spray opening (6) of the main line (5) by the high-pressure pump (4); and
two electric motors (10, 20), including
a first electric motor (10) operatively connected to the gearbox (30) for driving the high-pressure pump (4), the first electric motor (10) generating a first amount of power, and
a second electric motor (20) operatively connected to the gearbox (30) for driving the high-pressure pump (7), the second electric motor (20) generating a second amount of power,
wherein the gearbox (30) is designed such that the first amount of power and the second amount of power can be simultaneously transferred to the output shaft (31).

2. The pressure washer according to claim 1,
wherein the first electric motor (10) is an alternating current motor.

3. The pressure washer according to claim 1,
wherein the first electric motor (10) is a universal motor.

4. The pressure washer according to claim 1,
wherein the second electric motor (20) is a direct current motor.

5. The pressure washer according to claim 1,
wherein the second electric motor (20) is a brushless direct current motor.

6. The pressure washer according to claim 1,
wherein the second electric motor (20) is an electronically commutated motor.

7. The pressure washer according to claim 1,
wherein the first electric motor (10) can be supplied by an external energy source.

8. The pressure washer according to claim 1,
wherein the first electric motor (10) can be supplied by an alternating current voltage.

9. The pressure washer according to claim 1,
wherein the first electric motor (10) can be supplied by a mains voltage.

10. The pressure washer according to claim 1,
further comprising a battery (21),
wherein the pressure washer (1) is configured to supply the second electric motor (20) with electrical energy from the battery (21).

11. The pressure washer according to claim 1,
wherein the gearbox (30) is designed such that selectively
the two electric motors drive the output shaft (31) simultaneously, or
only one of the two electric motors drives the output shaft (31).

12. The pressure washer according to claim 1,
wherein the gearbox (30) comprises at least one freewheel (32, 33) which, when the output shaft (31) is driven by only one of the two electric motors (10, 20), prevents a power transmission from an active one of the two electric motors (10, 20) to an inactive one of the two electric motors (10, 20).

13. The pressure washer according to claim 1,
wherein the first electric motor (10) and the second electric motor (20) are electrically separated from each other.

14. The pressure washer according to claim 1,
wherein the output shaft (31) of the gearbox (30) is a single output shaft (31).

15. The pressure washer according to claim 1,
wherein the gearbox (30) is a planetary gear system.

16. The pressure washer according to claim 15,
wherein the planetary gear system comprises
a sun gear (34),
a ring gear (35), and
planet gears (36).

17. The pressure washer according to claim 16,
wherein one of the two electric motors (10, 20) can drive the sun gear (34) and another of the two electric motors (10, 20) can drive the ring gear (35).

18. The pressure washer according to claim 17,
wherein the first electric motor (10) can drive the sun gear (34), and wherein the second electric motor (20) can drive the ring gear (35).

19. The pressure washer according to claim 16,
wherein the output shaft (31) can be driven by the planet gears (36), and
wherein the planet gears (36) can be driven by the sun gear (34) and/or the ring gear (35).

20. The pressure washer according to claim 19,
wherein the output shaft (31) for driving the high-pressure pump (1) can be rotated about an axis of rotation (50), and
wherein the planet gears (36) can be driven by the sun gear (34) and/or the ring gear (35) to rotate about the axis of rotation (50).
